(19) United States
(12) Patent Application Publication
(10) Pub. No.: US 2021/0400913 A1
(43) Pub. Date: Dec. 30, 2021

(54) DOSING SYSTEM AND METHOD

(71) Applicant: D.I.T Technologies Ltd, Highfields, Queensland (AU)

(72) Inventors: Thomas Robinson Feez, Withcott, Queensland (AU); Mark Rawlinson Peart, Geham, Queensland (AU)

(21) Appl. No.: 17/288,779

(22) PCT Filed: Oct. 29, 2019
(86) PCT No.: PCT/AU2019/051184

§ 371 Date: Apr. 26, 2021

(30) Foreign Application Priority Data
Nov. 1, 2018 (AU) 2018904163

(51) Int. Cl. A01K 7/02; C02F 1/68; C02F 1/00

(52) U.S. Cl. CPC A01K 7/02; C02F 1/686; C02F 2209/40; C02F 2201/009; C02F 2209/05; C02F 1/008

(57) ABSTRACT

A dosing system for dosing a liquid additive into a water supply line for livestock, the dosing system comprising: a first connector configured to be fluidly coupled with a liquid additive supply line to a supply of the liquid additive; a second connector configured to be fluidly coupled with a dosage line for dosing the liquid additive into the water supply line, a pump unit coupled with the first connector for pumping the liquid additive from the supply line, the pump being fluidly coupled with a dosage outlet for dosing the pumped liquid additive into the water supply line via the first connector; and a control unit being operatively coupled with the pump unit for controlling a dosage rate of the liquid additive being dosed through the dosage outlet; and a flow sensor for sensing water flow rate in the water supply line and transmitting data associated with the sensed water flow rate to the control unit to control operation of the pump unit thereby controlling the dosage rate of the liquid additive in response to the flow rate in the water supply line.

### TECHNICAL FIELD

The present invention relates to a dosing system for dosing a liquid additive into a water supply line. In particular, the present invention finds advantageous, but not exclusive application in the livestock sector for dosing one or more water supply lines used for supplying drinking water to livestock.

### BACKGROUND

Any references to methods, apparatus or documents of the prior art are not to be taken as constituting any evidence or admission that they formed, or form part of the common general knowledge.

The use of drinking water for distributing supplements to livestock is well known. A variety of devices and systems have been designed for the dispensing of nutrients, minerals and supplements to livestock through stock water supplies. These devices and systems historically relied on the use of a mixing tank, in which the additive is diluted before being pumped into the stock water supply. Newer devices have been developed that dose the additive directly into the stock water without the use of a mixing tank. However, there are a number of shortcomings and problems with the existing devices and systems.

The use of mixing tanks is not suitable for at least some additives that have a shelf life shorter than the period in which the mix can be dispensed to stock. Organic compounds, such as seaweed extracts, require dispensing to stock within a short time of being diluted. As a result, the use of mixing tanks can often limit the range of supplements that can be administered to livestock animals in an effective manner.

Another disadvantage associated with the use of mixing tanks for administering supplements is that some of the supplements may not be fully dissolved in water and may therefore settle at the bottom of the mixing tank because manual mixing of such additives or supplements in large quantities can be quite challenging. As a result, higher than optimal concentrations of additives may be inadvertently discharged into to stock water, which can cause health risks to stock and/or unpalatability of water supplies.

The process of pouring liquid additives into mixing tanks and ensuring that adequate mixing has been achieved can also be a significantly labour intensive and increase costs. Furthermore, manually carrying out mixing in large mixing tanks can give rise to significant workplace health and safety risk, especially in remote locations where additives are often used and graziers are often working alone.

The use of diaphragm pumps for dosing of liquid additives into drinking water supply line is known. One of the disadvantages with Diaphragm pumps is that such pumps are not capable of pumping exceptionally viscous additives and can get clogged. This is especially the case during events of extreme temperature change or after periods in which no additive is dispensed for a time. Another disadvantage associated with the use of diaphragm pumps in currently known systems is that in the event of loss of power or other breakdown, allow liquid to syphon through the pump. Where additives are toxic in high doses, such as in the use of Urea, this problem in the use of existing pumps can be fatal to stock.

Yet another problem with currently known dosing systems is that such systems cannot dispense supplements with high levels of accuracy. When trace minerals or other additives are being provided to stock to overcome specific dietary deficiencies, or when stock are drinking low levels of water, high levels of accuracy of additives made via stock water is essential but cannot be met with current systems. By way of example, in some instances, very small doses (for example 2mL/animal/day) may be required to be dispersed when using some trace mineral additives, medicated additives and similar products.

At least some prior art dosing systems are set or programmed to work on a consistent rate of dosing. However, such systems cannot account for varying levels of water consumption or varying levels of flow rate of water. In some instances, where alternative water supplies are available to stock, continuous release of additives can result in very high concentrations being supplied into water supplies, which can cause health risks to stock and/or unpalatability of water supplies.

In view of the above, there is at least a need to provide an improved dosing system.

### SUMMARY OF INVENTION

In an aspect, the invention provides a dosing system for dosing a liquid additive into a water supply line for livestock, the dosing system comprising: a first connector configured to be fluidly coupled with a liquid additive supply line to a supply of the liquid additive;

a second connector configured to be fluidly coupled with a dosage line for dosing the liquid additive into the water supply line, a pump unit coupled with the first connector for pumping the liquid additive from the supply line, the pump being fluidly coupled with a dosage outlet for dosing the pumped liquid additive into the water supply line via the first connector; and a control unit being operatively coupled with the pump unit for controlling a dosage rate of the liquid additive being dosed through the dosage outlet; and a flow sensor for sensing water flow rate in the water supply line and transmitting data associated with the sensed water flow rate to the control unit to control operation of the pump unit thereby controlling the dosage rate of the liquid additive in response to the flow rate in the water supply line.

In an embodiment, the control unit comprises a microprocessor in communication with a memory device wherein the microprocessor is arranged to receive the data associated with the water flow rate to process the data in accordance with one or more predetermined rules saved on the memory device and control operation of the pump unit thereby controlling the discharge rate of the liquid additive in response to the flow rate in the water supply line.

In an embodiment, the dosing system further comprises an input interface for receiving user input from a user for inputting one or more predetermined rules or instructions for controlling operation of the control unit.

In an embodiment, the dosing system further comprises an additional sensor for sensing changes in conductivity and/or dielectric properties of the water in the water supply line, the sensor being in communication with the control unit to control operation of the pump thereby controlling the discharge rate of the liquid additive in response to changes in conductivity and/or dielectric properties of the water.

In one embodiment, the system further comprises one or more alarms that are operatively coupled with said microprocessor such that the alarms are adapted to be activated in response to changes in conductivity and/or dielectric properties of the water in the water supply line. In a further embodiment, the alarm may be programmed for being activated when the conductivity and/or dielectric properties exceed a preset or predetermined threshold.

In an embodiment, the pump unit is a peristaltic pump configured to measure and deliver a dose of liquid additive into the livestock water supply line.

In an embodiment, the dosing system further comprises a diaphragm pump coupled with the discharge outlet to pump the liquid additive into the water supply line.

In an embodiment, the dosing system further comprises a valve fluidly coupled to the discharge line to prevent water from the water supply line from flowing back to the dosing system. Preferably, the valve is a solenoid valve.

In an embodiment, the dosing system further comprises a trans-receiver coupled with the control unit, the trans-receiver being adapted for communication with a remotely located device over a communication network.

In an embodiment, the dosing system further comprises a reservoir for supplying the liquid additive, the reservoir adapted to be coupled to the liquid additive supply line.

In an embodiment, the water supply line comprises a pressurised water supply line and wherein the system further comprises an additional pumping unit for pumping the liquid additive from the discharge outlet into the pressurised water supply line via the first connector.

In an embodiment, the control unit comprises an adjustment arrangement to limit rate the dosage rate of the liquid additive in a predetermined range.

In an embodiment, the dosing system further comprises a power unit for powering the control unit and the pump unit.

In an embodiment, the power unit comprises one or more energy generators and one or more energy storage devices.

In another aspect, the invention provides a method of dosing a liquid additive into a water supply line for livestock, the dosing method comprising:

fluidly coupling a first connector with a liquid additive supply line adapted to supply the liquid additive;

fluidly coupling a second connector with a dosage line for dosing the liquid additive into the water supply line,

fluidly coupling a pump unit with the first connector for pumping the liquid additive and fluidly coupling the pump unit with the second connector for directing the pumped liquid additive to a dosing outlet; and

sensing flow rate of water in the water supply line by locating a flow sensor in the water supply line and transmitting data associated with the sensed water flow rate to a control unit to control operation of the pump unit to control the dosage rate of the liquid additive in response to the flow rate in the water supply line.

### BRIEF DESCRIPTION OF THE DRAWINGS

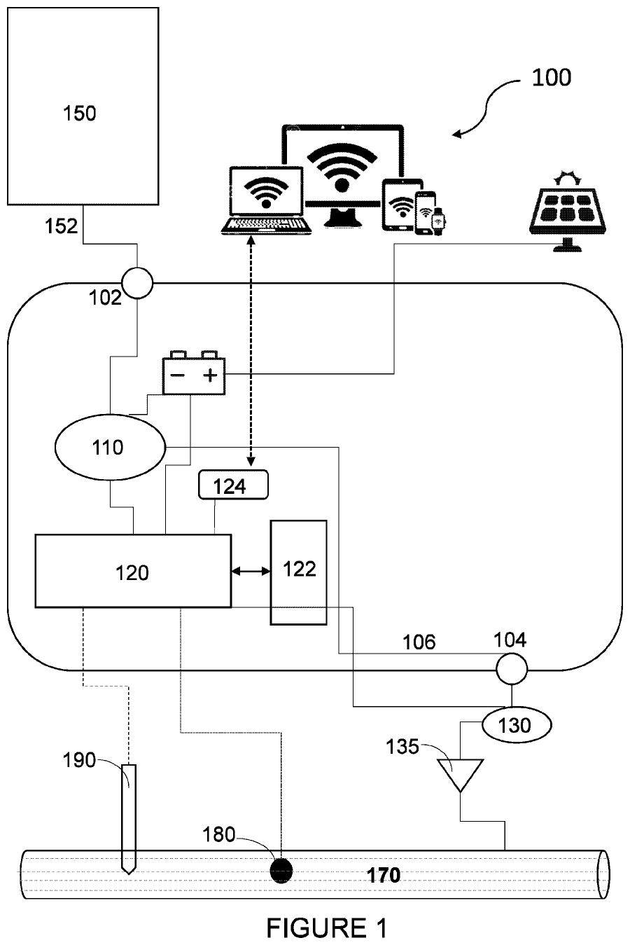

Preferred features, embodiments and variations of the invention may be discerned from the following Detailed Description which provides sufficient information for those skilled in the art to perform the invention. The Detailed Description is not to be regarded as limiting the scope of the preceding Summary of the Invention in any way. The Detailed Description will make reference to a number of drawings as follows: FIG. 1 is a schematic illustration of a system 100 in accordance with an embodiment.

### DETAILED DESCRIPTION OF PREFERRED EMBODIMENTS

Referring to FIG. 1 a first embodiment of the present invention in the form of a system 100 for dosing a liquid additive directly into a livestock water supply line 170. The system 100 comprises a first connector 102 that is fluidly coupled with a reservoir 150 of the liquid additive via a liquid additive supply line 152 to a pumping device 110. The pumping device 110 is operated by being connected to a controller 120. During use, the controller 120 is adapted to operate the pumping device 110 to measure and deliver a dose of liquid additive by pumping the liquid additive from the reservoir 150 (stored in undiluted concentrate form) and conveying the dose of the liquid additive into a water supply line 170 that is used for delivering drinking water to livestock. Specifically, the system 100 comprises a coupling 104 that can be coupled to a dosing line 106 and an additional pump 130 to pump the dosed liquid additive into the water supply line 170.

In the preferred embodiment, the pumping device 110 is provided in the form of a peristaltic pump. In a peristaltic pump the fluid is contained within a flexible tube fitted inside a circular pump casing (though linear peristaltic pumps have been made). A rotor with a number of “rollers”, “shoes”, “wipers”, or “lobes” attached to the external circumference of the rotor compresses the flexible tube. As the rotor turns, the part of the tube under compression is pinched closed (or “occludes”) thus forcing the fluid to be pumped to move through the tube. Additionally, as the tube opens to its natural state after the passing of the cam (“restitution” or “resilience”) fluid flow is induced to the pump 110. This process is called peristalsis and is used in many biological systems such as the gastrointestinal tract. The advantage of peristaltic pump 110 in the system 100 is that such a pump can deliver highly viscous fluids at a variable rate and prevents such fluids from being syphoned back into the additive supply line 102 when not in use.

The peristaltic pump 110 is controlled by a control unit 120 which comprises an electronic controller that includes a processor that is operatively connected with a non-volatile memory device 122. One or more executable instructions may either be saved on the memory device 122 or may also be written onto the memory device 122. The system 100 includes a flow rate sensor device(s) 180 that is arranged in the water supply line 170 to sense the flow rate of water flowing through the water supply line 170. The flow rate sensing device(s) 180 include a transmitter to transmit data associated with the flow rate of the water to the control unit 120. The control unit 120 processes the transmitted data associated with the flow rate of the water supply line 170 and in response controls the operation of the pumping device 110 thereby controlling the dosage rate of the liquid additive in response to the flow rate in the water supply line. One or more specific rules may be written onto the memory device 122 to compute dosage rates for specific liquid additives in response to the flow rate of water sensed by the sensing device(s) 180 in the water supply line 170. The control unit 120 may also be optionally controlled via an application on smartphone or computer tablet so that dosing rates can be adapted, water flow rates can be monitored and volume of additive dispensed over time can be tracked. By way of example, the control unit 120 may include a trans-receiver for transmitting and receiving electromagnetic signals over a network (wired or wireless) for communication with one or more remotely located computing devices or even satellites. The control unit 120 and the pumps 110 and 130 may be powered by an on-board energy storage device (such as a 12V battery). The energy storage source may be preferably rechargeable and may be connected to one or more photo-voltaic panel which may be used for recharging the energy storage device.

The incorporation of feedback control of the pump unit 110 to control dosing rates based on flow rates of water in the water supply line 170 provides a key advantage over the prior art. Prior art dosing system provide a constant rate of dosing and are unable to account for varying levels of stock water consumption. By way of example, during some weather periods, alternative water supplies may become to stock and continuous release of additives can result in very high concentrations being supplied into livestock drinking water supplies, which can cause health risks to stock and/or unpalatability of water supplies. The use of the flow rate sensing device(s) 180 to effectively control dosing rate in the system 100 prevents high concentrations of additives from being inadvertently dosed in drinking water supply lines.

In a multi-field system within a farm/grazing area boundary the system 100 of the present invention can supplement the additive proportionally to each water trough livestock drinking area of the multi-field system. By way of example, branches of the dosing line 106 may be used to dose several water supply lines supplying drinking water to several water troughs in the farm/grazing area. The flow of liquid additives in accordance with a dosing rate from the dosing line 106 may be controlled by the control unit 120 in response to feedback received from flow sensing devices installed in the water supply lines supplying water to the several water troughs.

A diaphragm pump (as a 107 psi Shurflo pump or any other pump) may be coupled to the second coupling 104 to pump the dosed liquid additive into the water supply line 170. In addition, a valve is fluidly coupled to the dosing outlet to prevent water from the water supply line 170 from flowing back towards the dosing system 100. In at least some embodiments, the valve may take the form of a solenoid valve that could be electrically actuated by the control unit 120.

In addition to the flow rate sensing device(s) 180, a conductivity or impedance measuring probing device(s) 190 may also form a part of the system. The probing device(s) may be positioned in the water supply line and an RF signal may be generated across a resonant circuit; which comprises of a variable inductor and capacitor. Electromagnetic radiation may be propagated into the water supply to monitor the level of liquid additive and other important parameters. Any changes in the conductivity and dielectric properties of the water supply (such as for example unusually high levels of urea phosphate) are likely to change the impedance and resonance of the circuit. These changes, proportional to liquid content and volume, are detected by an on-board microcontroller, or the like, and then transmitted to the main control unit 120 to regulate the dosing rate of the liquid additive in response to changes in conductivity or dielectric properties of the water.

In at least some embodiments, an alarm may be operatively coupled with the microprocessor such that the alarm is programmable to be activated when the concentration of proportion of an additive is greater than a preset level. In at least some embodiments, the dosage level may be calculated by taking the number of nutrient pulses, then converting into milliliters using an arbitrary factor and then dividing that into 10 liters and then comparing it to the alarm level setting. The provision of the alarm is an important feature in that it alerts a user to check and shut down the dosing unit if necessary and avoid issues associated with overdosing of the water with highly undesirable quantities of additives and/or supplements.

It would be understood that the dosing system 100 may be sold in the form of a kit comprising several parts including the pumping device 110, the control unit 120, the flow sensor 170 and one or more of the other parts as previously described to allow a user to install the dosing system 100 on a farm or grazing property.

The dosing system 100 may provide several non-limiting advantages over the prior art, some of which have been listed below:
Improved ease of use in supplying additive to a livestock water supply for the following reasons:
   The system can be controlled via wireless or telemetry I UHF radio, allowing for remote monitoring of water use and availability and volume of additive remaining. The pump can be adjusted or engaged/disengaged without physically accessing the watering point;
   The system may make use of solar panel battery recharging to ensure continuity of use; and
   The system can utilise an ultrasonic water flow meter, eliminating the need for cutting and re-joining the water pipe. A cheaper technology such as multi-jet flow pumps can be used in the alternative if unit cost is a limiting factor.
Improved efficiency of supplying additive to a livestock water supply for the following reasons:
   The system does not rely on the use of a mixing tank;
   The system is calibrated to be extremely accurate;
   The system injects additives into flowing water, allowing for maximum mixing into the water supply;
   The system injects additives only when required, preserving the shelf life of additives;
   The software application that controls the system can provide data on water flow and rate and volume of additive dispensed; and
   The system can be adapted to attach directly to a range of container sizes and shapes, eliminating the need for transfer of additive products from the container of initial supply.
   The system incorporates safety features such as alarms to ensure safe use of urea.

In compliance with the statute, the invention has been described in language more or less specific to structural or methodical features. The term “comprises” and its variations, such as “comprising” and “comprised of” is used throughout in an inclusive sense and not to the exclusion of any additional features.

It is to be understood that the invention is not limited to specific features shown or described since the means herein described comprises preferred forms of putting the invention into effect.

The invention is, therefore, claimed in any of its forms or modifications within the proper scope of the appended claims appropriately interpreted by those skilled in the art.

1. A dosing system for dosing a liquid additive into a water supply line for livestock, the dosing system comprising:
a first connector configured to be fluidly coupled with a liquid additive supply line to a supply of the liquid additive;
a second connector configured to be fluidly coupled with a dosage line for dosing the liquid additive into the water supply line,
a pump unit coupled with the first connector for pumping the liquid additive from the supply line, the pump being fluidly coupled with a dosage outlet for dosing the pumped liquid additive into the water supply line via the first connector; and
a control unit being operatively coupled with the pump unit for controlling a dosage rate of the liquid additive being dosed through the dosage outlet; and
a flow sensor for sensing water flow rate in the water supply line and transmitting data associated with the sensed water flow rate to the control unit to control operation of the pump unit thereby controlling the dosage rate of the liquid additive in response to the flow rate in the water supply line.

2. The dosing system in accordance with claim 1 wherein the control unit comprises a microprocessor in communication with a memory device wherein the microprocessor is arranged to receive the data associated with the water flow rate to process the data in accordance with one or more predetermined rules saved on the memory device and control operation of the pump unit thereby controlling the discharge rate of the liquid additive in response to the flow rate in the water supply line.

3. The dosing system in accordance with claim 2 further comprising an input interface for receiving user input from a user for inputting one or more predetermined rules or instructions for controlling operation of the control unit.

4. The dosing system in accordance with claim 2, further comprising an additional sensor for sensing changes in conductivity and/or dielectric properties of the water in the water supply line, the sensor being in communication with the control unit to control operation of the pump thereby controlling the discharge rate of the liquid additive in response to changes in conductivity and/or dielectric properties of the water.

5. The dosing system in accordance with claim 4, wherein the system further comprises one or more alarms that are operatively coupled with said microprocessor such that the alarms are adapted to be activated in response to changes in conductivity and/or dielectric properties of the water in the water supply line.

6. The dosing system in accordance with claim 5, wherein the said alarms are adapted to be programmed for being activated when the conductivity and/or dielectric properties exceed a preset or predetermined threshold.

7. The dosing system in accordance with claim 1, wherein the pump unit is a peristaltic pump configured to measure and deliver a dose of liquid additive into the livestock water supply line.

8. The dosing system in accordance with any one of the preceding claims claim 1, further comprising a diaphragm pump coupled with the discharge outlet to pump the liquid additive into the water supply

9. The dosing system in accordance with claim 1, further comprising a valve fluidly coupled to the discharge line to prevent water from the water supply line from flowing back to the dosing system.

10. The dosing system in accordance with claim 9 wherein the valve is a solenoid valve.

11. The dosing system in accordance with claim 1, further comprising a trans-receiver coupled with the control unit, the trans-receiver being adapted for communication with a remotely located device over a communication network.

12. The dosing system in accordance with claim 1, further comprising a reservoir for supplying the liquid additive, the reservoir adapted to be coupled to the liquid additive supply line.

13. The dosing system in accordance with claim 1, wherein the water supply line comprises a pressurized water supply line and wherein the system further comprises an additional pumping unit for pumping the liquid additive from the discharge outlet into the pressurized water supply line via the first connector.

14. The dosing system in accordance with claim 1, wherein the control unit comprises an adjustment arrangement to limit rate the dosage rate of the liquid additive in a predetermined range.

15. The dosing system in accordance with claim 1, further comprising a power unit for powering the control unit and the pump unit.

16. The dosing system in accordance with claim 15, wherein the power unit comprises one or more energy generators and one or more energy storage devices.

17. A method of dosing a liquid additive into a water supply line for livestock, the dosing method comprising:
fluidly coupling a first connector with a liquid additive supply line adapted to supply the liquid additive;
fluidly coupling a second connector with a dosage line for dosing the quid additive into the water supply line,
fluidly coupling a pump unit with the first connector for pumping the liquid additive and fluidly coupling the pump unit with the second connector for directing the pumped liquid additive to a dosing outlet; and
sensing flow rate of water in the water supply line by locating a flow sensor in the water supply line and transmitting data associated with the sensed water flow rate to a control unit to control operation of the pump unit to control the dosage rate of the liquid additive in response to the flow rate in the water supply line.
